(19) United States
(12) Patent Application Publication
(10) Pub. No.: US 2012/0109396 A1
(43) Pub. Date: May 3, 2012

(54) Industrial process communication system

(75) Inventor: Hong Yu, Hollis, NH (US)

(73) Assignee: Aboundi, Inc.

(21) Appl. No.: 12/925,775

(22) Filed: Nov. 1, 2010

(51) Int. Cl. G06F 1/26

(52) U.S. Cl. 700/295

(57) ABSTRACT

An industrial or manufacturing communication system and devices typically used in an industrial environment including several industrial devices such as work stations wherein a work station power distribution line runs along side the work flow or conveyor line, with individual data units connected between the individual work stations and the power distribution line, and further includes a similar connection by a data unit between a process controller and the power distribution line, wherein a selective flow of data is provided between and/or among the individual work stations and/or a workstation and the process controller. Further embodiments include the powering of the data units from power derived from the power distribution line(s), and integration and/or embedding some or all of the communications elements of the present invention into the structure, e.g. circuit boards, of the workstations and other devices connected to primary and/or secondary power lines.

### FIELD OF THE INVENTION

The present invention relates to data communication systems, in particular, to Ethernet-centric industrial process multi-point data communication systems between and among process workstations and process monitor and control devices.

### BACKGROUND OF THE INVENTION

Industrial environments and processes include manufacturing or processing sub-components that are located or are arranged in parallel and/or in sequence until the end of the process. Each manufacturing or processing sub-component often communicates with other sub-components or a controller, typically a programmable logic device, e.g. a specialized processor. Due to the nature of the industrial process, such sub-components are widely physically distributed in a somewhat hostile industrial environment, yet is required to be tightly integrated to maintain efficient execution of the process, which requires flexible and easy installation and reliable operation over the lifetime of the industrial process.

One example 50 of a prior Ethernet-centric data communication between workstations 52A-52F along a manufacturing line 40 is shown in FIG. 1, wherein each workstation 52A-52F are individually connected, typically via CAT-5 cabling 54A-54F, to a common network switch 56 which allows data communication between a process control computer 58 and one or more of the workstations 52A-52F. However, each individual connection cabling 54A-54F must make a “home run” to the possibly distant network switch 56, often physically harsh environment and through an electrically ‘dirty’ environment which severely limits signal fidelity and bandwidth which significantly increase the costs and maintenance.

A second example 60 of a prior data communication system is seen in FIG. 2, which ‘daisy-chains’ together Ethernet switches 62A-62F, wherein each switch 62A-62F is connected to a corresponding workstation 52A-52F, and to the succeeding and preceding switch. However, failure one of the switches 62A-62F, (and Programmable Logic Controller 58 optional switch 62G) or other interruption or signal corruption in the data path connecting the switches 62A-62F, 62G interferes or stops subsequent signal flow and disables the manufacturing process in a “bus” topology. In the event of a “ring” configuration protection topology (mode), the recovery ring will re-establish the loop (ring), but in the event of a ‘non-clean’ break, e.g. an intermittent connection, further degradation occurs with oscillation between primary and secondary recovery modes.

Meanwhile, in either prior systems and in many industrial processes, an entirely separate power distribution line 70 is run generally along the conveyor or product flow of the manufacturing process. Such power distribution lines provide a power to the industrial process typically in the range of 12 VDC to 48 VDC, but not limited thereto, and as a result of the various equipment connected thereto additionally have severe amounts of noise often spectrally concentrated at certain frequencies (and their harmonics) which may change according to the industrial process demand.

### SUMMARY OF THE INVENTION

An embodiment of the present industrial communication system and devices are typically used in an industrial environment with a process that includes a number of workstations or process operations along the work flow or the conveyor line, and includes the workstation power distribution line running along side the work flow or cell-based manufacturing line, with individual data units connected between the individual workstations and the power distribution line, and may further include a similar connection by a data unit between a process controller and the power distribution line, wherein a selective flow of data is provided between and/or among the individual work stations and/or a workstation and the process controller.

Further inventive features include a secondary or redundant power distribution line to which the individual data units may also be connected and data selectively transmitted therethrough for additional bandwidth, alternate control signals or a substitute primary data path in the event of primary power line failure or deteriorated transmission quality. Moreover, the present invention includes embodiments that differentially apply to and receive from the power line(s) signals having dynamically adjusted spectrum (including signal carriers, sidebands and/or notches) which may adapt to the existing level of non-DC noise present. Further embodiments include the powering of the data units from power derived from the power distribution line(s), and integration and/or embedding some or all of the communications elements of the present invention into the structure, e.g. circuit boards, of the workstations and other devices connected to primary and/or secondary power lines.

The embodiments of the present invention provide a robust, reliable, flexible, easily installed or modified, and relatively low maintenance cost communication system, uniquely adapted to the existing, often harsh industrial environment and the existing infra-structures.

### BRIEF DESCRIPTION OF THE DRAWING

These and further features of the present invention will be better understood by reading the following Detailed Description together with the Drawing, wherein

FIG. 1 is a block diagram of a prior art data distribution system having a traditional switch architecture;

FIG. 2 is a block diagram of a prior art data distribution system having a low port count switch in a daisy-chain logical bus or ring architecture;

FIG. 3 is a block diagram of an exemplary embodiment of the present invention;

FIG. 4 is a block diagram of further details of a portion of an exemplary embodiment of the present invention;

FIG. 5 is a block diagram of a sub-portion of an exemplary embodiment of the present invention; and

FIG. 6 is a block diagram of an embedded embodiment of the present invention.

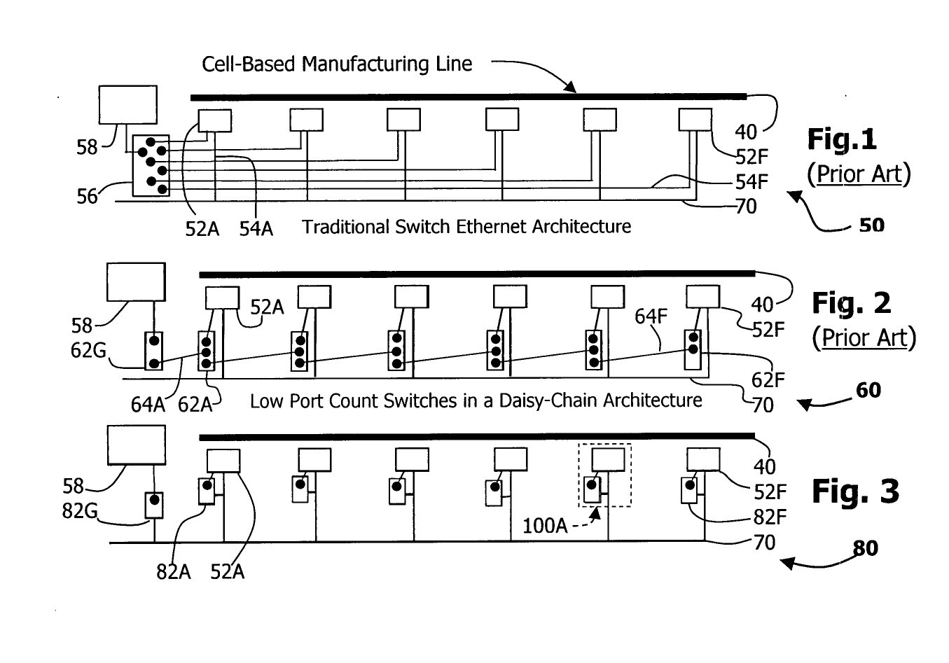

### DETAILED DESCRIPTION

An exemplary embodiment 80 according to the present invention is shown in FIG. 3, wherein a cell-based manufacturing line 40 is associated with various manufacture or process steps, components or locations along which a number of workstations 52A-52F are generally placed, and may be similar or different. The number of workstations is not limited. The workstations 52A-52F may directly interact with the manufacturing product or step and/or may include or involve human interaction. Each workstation 52A-52F receives operating power from power supply mains 70, e.g. a 11-48 VDC power line running generally together with the manufacturing line 40. Each workstation 52A-52F has a corresponding data (interface) unit 82A-82F, is also connected to the manufacturing supply mains 70 through which data is sent and received to other data units, and in most embodiments, data unit operating power is also received. In the exemplary embodiment, the individual workstations 52A-52F selectively communicate with each other, and/or with a programmable logic controller (e.g. a process control computer) 58 via the manufacturing supply 70 through its own data unit 82G.

A further detail of a portion of an exemplary embodiment is shown in FIG. 4, wherein an exemplary data unit 92 is connected to a manufacturing power supply 72P distributed by manufacturing supply line 70P via connection path 74P. In many instances the manufacturing supply line 70P comprises two or more parallel or twisted wires. If such plural manufacturing supply wires are used, one embodiment of the present invention provides plural wires in the connecting path 74P, optionally of similar (parallel, twisted, etc.) kind. Notwithstanding the intended purpose of providing a substantially constant-voltage power to loads along the manufacturing line, according to the present invention, the plural supply wires may further be differentially driven with the data unit signals, e.g. by a transformer or isolation transformer winding or equivalent, connected across power line wires. In a broad exemplary concept, the Power Line Device (PLD) which places data on an DC power line, the Programmable Logic Controller (PLC), necessary Band-Pass, Low-Pass and/or High-Pass filtering (BPF), and controlled workstation Device (Dev) may be consolidated in a single apparatus 94 within the data unit 92, and may, in some embodiments, include the workstation apparatus or devices. The consolidated apparatus 94 is also powered by the manufacturing supply line 70P.

In manufacturing or conveyor application embodiments having redundant, back-up or secondary power supplies 72S, and secondary connecting line 70S, having wires similar or dissimilar to what is the primary line 70P. According to one embodiment of the present invention, the consolidated apparatus 94 of the data unit 92 is connected to the secondary lines 70S for data sending and/or receiving, operating power, or both with a connecting path 74S similar or dissimilar to the connecting path 74P. When both primary 70P and secondary 70S lines are used to power the data unit, power steering devices 96P, 96S are used to selectively receive power from either or both primary 70P and secondary 70S lines (via optional internal Low-Pass Filters) without interference or unwanted power or signal flow, and are shown in one embodiment as each represented by a diode.

The consolidated device 94 receives data from either or both primary 70P and/or secondary 70S power lines with a hardware or software switch, selector, combiner, etc. (not shown) within the consolidated device. Similarly, the data unit 92 and/or consolidated device 94 include hardware or software switch, selector, output driver or connection of data signals provided to either or both primary 70P and/or secondary 70S lines. In alternate embodiments where distinct data is provided over different power lines (e.g. 70P, 70S) to which the data unit is connected, incoming and outgoing data isolation is also provided in the hardware or software switch, selector, combiner, output driver, etc. with an appropriate data isolator or data isolation process.

Moreover, the present invention may include other data connections, such as to a programmable logic controller 58 as shown in FIG. 3, or another network 104 such as a Local Area Network (LAN) or Wide Area Network, Ethernet, or other network with a corresponding PLD data unit 102 providing an interface to an exemplary supply line, e.g. 70P.

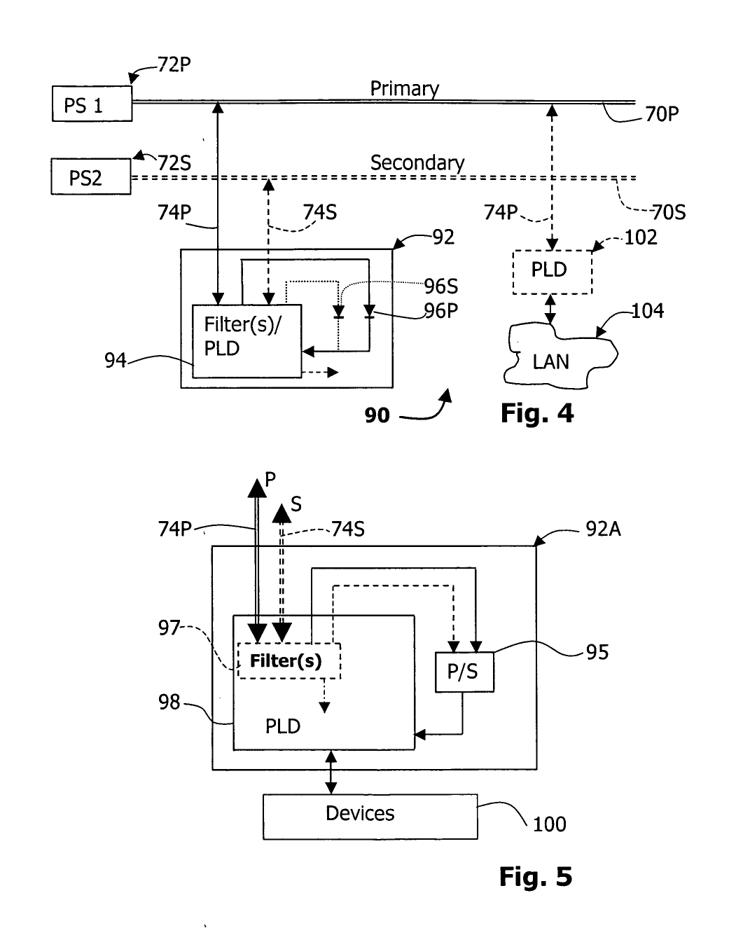

A different configuration is shown in FIG. 5, wherein the devices 100 are external to the data unit 92A and are connected to one or more supply lines with connecting path 74P (and/or optionally connecting path 74S). Often data unit 98 operating power is dissimilar to the voltages needed, and a data unit power supply 95 is included. The power supply 95 is connected to a supply line (e.g. 70P, 70S) via an optional low-pass filter, and if connected to more than one, a power steering device, e.g. a diode (e.g. 96P, 96S of FIG. 4), is used to provide power line isolation and energy steering into the power supply 95. Data line interface devices such as filter(s) 97 which provide band-pass filtering of the data signals of interest and a low-pass filtered power connection to the power supply 95, and/or PLD is also included within the PLC process controller in FIG. 5, 98 and/or the other embodiments.

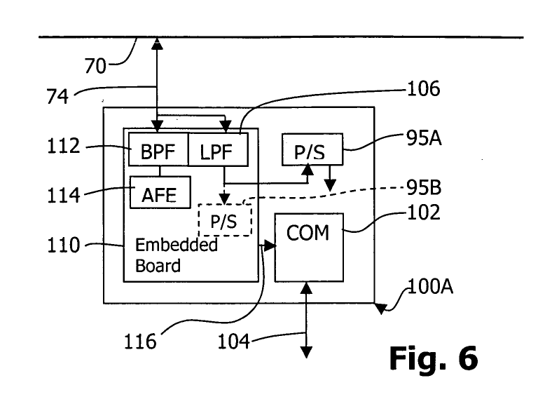

In another embodiment, the industrial device 100A of FIG. 6 itself includes a communication section 102 or circuit board co-located with the embedded data unit circuitry 110 also receiving data and operating power from the power line 70, and providing a communication path with the communication section 102 of the industrial device 100A. In higher levels of integration, the data unit circuit 110 according to the present invention is integrated with the communication sections, and both are optionally integrated into the industrial device 100A circuitry, signal and data processing, and/or circuit boards. In the simplified block drawing of FIG. 6, only a single power line 70 (and connecting path 74) is shown. However, multiple power lines, e.g. for primary and secondary/backup power lines 70P and 70S, above, are applicable to the industrial device 100A as taught for the above embodiments. The power supply 95A is connected to the power line 70 but selectively isolated by a low-pass filter that reduces unwanted signal from the power supply 95A introduced to the power line 70. The power supply 95A provides operating power at least to the components of industrial device 100A. The resulting industrial device is placed along the manufacturing line 40 with and among other (or similar) devices or workstation as shown in FIG. 3.

The embedded data unit 110 includes a band-pass filter 112 which provides signals to and from the power line 70 via power line connection 74, and provides data signals to and from the subsequent circuitry via an Analog Front End (AFE) 114 or equivalent transitional circuitry, the data circuitry often including an Ethernet data path 116 to the communication circuitry 102. The typical PLD and the embedded board 110 may include therein a bi-directional communications transceiver ‘engine’ which functions to translate data to (and from) a data unit format from (and to) a format better suited for the power line 70, connected to the power line 70 via the AFE 114 which bi-directionally converts the data signals to (and from) the communications engine to (and from) signals better suited to the power line 70. The signals to (and from) the AFE 114 from (and to) the power line 70 pass through band-pass filters (or bi-directional filter) 112 which relatively reduce unwanted signals not associated with data unit and power line signals, and the associated power supply low-pass filter 106 selectively reduces signals generated by the power supply 95A from entering the power line 70 from which the power supply receives its operating power and interfering with the signals within the BPF 112 pass band. The embedded board 110 may optionally include its own power supply, 95B, also connected to the power line 70 via LPF 106. When secondary or back-up power lines (e.g. 70S) are used, the industrial device embedded board may include further switching and/or coupling elements to provide the desired signal connections from the data units selectively to one or both primary and secondary power lines, and such switching and/or coupling elements may be included within at least the BPF 112 and/or the AFE 114 and/or the board communications engine, and/or additionally and separate therefrom.

While the industrial device 100A may include the necessary workstation components and/or functions, the industrial device 100A may further include an input/output (I/O) port connection 104 for connection to and control of external workstation apparatus, e.g. a robotic arm.

In one embodiment of the present invention, the PLC, PLD, the AFE, and/or associated communication engines, together or individually produce wide-band signals applied to or received from the power line(s) which are not limited to single carriers, single channels, spectrum, or modes of modulation, but may include structures which provide real-time, agile and/or dynamically allocated signals in response to the signal and/or noise conditions of the connected power line(s). An exemplary modulation technique and apparatus is provided by DS2 technology of Marvel, Santa Clara, Calif., according to OFDM protocol, incorporated by reference, which is provided by the above-referenced data unit elements.

Alternate embodiments having DC power of a different voltage range, are within the scope of the present invention. Moreover, while the protocol used is the Ethernet data protocol, other protocols may also be used. Further modifications of the present invention made by one of ordinary skill are within the scope of the present invention, which is not limited, except by the claims that follow.

What is claimed is:

1. A industrial process data distribution system, comprising:
a first workstation corresponding to a first process operation;
a second workstation corresponding to a second process operation;
a process primary power line extending between at least said first work station and said second work station; and
at least a first data unit connected to said first workstation and connected to said process primary power line, said first data unit providing a wide-band data flow between said first data unit and said process primary power line; and
a second data unit connected to said second workstation and connected to said process primary power line, said second data unit providing a wide-band data flow between said second data unit and said process primary power line.

2. The industrial process data distribution system of claim 1, wherein said first and second data units provide a flow a data between said first workstation and said second workstation.

3. The industrial process data distribution system of claim 1, further including a process monitor and control data unit connected to said process primary power line adapted to provide a flow of data to said process primary power line and to at least one of said first data unit and said second data unit.

4. The industrial process data distribution system of claim 3, wherein said process monitor and control data unit includes a process control computer.

5. The industrial process data distribution system of claim 1, further including a network access data unit connected to a network and said process primary power line adapted to provide a flow of data therebetween.

6. The industrial process data distribution system of claim 5, wherein said network comprises one of a WAN, LAN and Internet.

7. The industrial process data distribution system of claim 1, wherein said process primary power line comprises a plurality of wires, and at least one of said first data unit and said second data unit are connected to said process primary power line by one of parallel, coaxial, shielded and twisted plurality of conductors.

8. The industrial process data distribution system of claim 1, wherein said process first operation and said process second operation are sequential operations.

9. The industrial process data distribution system of claim 1, wherein at least one of said first data unit and said second data unit are adapted to receive operating power from said process primary power line.

10. The industrial process data distribution system of claim 9, further including a power supply connected to receive power from said process primary power line and provide operating power to a corresponding one of said first data unit and said second data unit.

11. The industrial process data distribution system of claim 1, further including a process secondary power line.

12. The industrial process data distribution system of claim 11, wherein said process secondary power line comprises a redundant power line.

13. The industrial process data distribution system of claim 11, wherein at least one of said first data unit and said second data unit is connected to said process secondary power line and adapted to selectively provide data between said one of said first data unit and said second data unit, and said process secondary power line via said process secondary power line.

14. The industrial process data distribution system of claim 13, wherein at least one of said first data unit and said second data unit are adapted to receive operating power from at least one of said process primary power line and said process secondary power line.

15. The industrial process data distribution system of claim 1, wherein at least one of said first data unit and said second data unit includes a programmable logic controller.

16. The industrial process data distribution system of claim 1, wherein at least one of said first data unit and said second data unit includes one of a high-pass and a low-pass filter.

17. The industrial process data distribution system of claim 1, wherein at least one of said first and said second data units are adapted to differentially apply data to and receive data from said process primary power line.

18. A method of providing data flow in an industrial process setting having a common process power line, comprising:
providing a wide-band power line data signal to said process power line corresponding to a first data signal from a first data unit; and
receiving said power line data signal from said power line and providing a corresponding second data signal to a second data unit.

19. The method of claim 18, further providing a data flow between said first data unit and a first workstation.

20. The method of claim 19, further including:
providing a data flow between said first data unit and a process control computer, and
controlling said first work station with said process control computer.

21. The method of claim 18, further including providing operating power for at least one of said first data unit and said second data unit from said power line.

22. The method of claim 18, further including
providing a backup power line,
connecting said first data unit and said second data unit to said backup power line, and
selectively providing a flow of data between said first data unit and said second data unit on at least one of said power line and said backup power line.

23. An integrated industrial device, comprising:
a manufacturing device receiving power from a manufacturing power line;
a data unit connected to said manufacturing device and connected to said manufacturing power line, said first data unit providing wide-band data flow between said manufacturing device and said manufacturing power line.

24. The integrated industrial device of claim 22, wherein said data unit is connected to receive operating power from said manufacturing power line.

25. The integrated industrial device of claim 24, further including a power supply to provide selected operating power to said data unit from said manufacturing power line.

26. The integrated industrial device of claim 24, further connected to a secondary power line and adapted to selectively receive operating power from at least one of said manufacturing power line and said secondary power line, and adapted to selectively provide a data path between said manufacturing device and at least one of said manufacturing power line and said secondary power line.
